(19) United States
(12) Patent Application Publication
(10) Pub. No.: US 2019/0131600 A1
(43) Pub. Date: May 2, 2019

(54) SAFETY LITHIUM-ION BATTERY SYSTEM

(71) Applicant: Commander Innovations, Inc., Holly, MI (US)

(72) Inventor: Kevin W. Griffin, Holly, MI (US)

(73) Assignee: Commander Innovations, Inc., Holly, MI (US)

(21) Appl. No.: 16/177,681

(22) Filed: Nov. 1, 2018

Related U.S. Application Data
(60) Provisional application No. 62/580,469, filed on Nov. 2, 2017.

(51) Int. Cl. H01M 2/10; H01M 10/0525; H01M 10/42; H01M 2/12; B01D 53/02

(52) U.S. Cl. CPC H01M 2/1072; H01M 10/0525; H01M 10/425; H01M 2/1235; B01D 2257/93; H01M 2010/4271; H01M 2220/20; H01M 2200/00; B01D 2253/102; B01D 53/02

(57) ABSTRACT

A battery housing, especially for lithium ion batteries, that is designed to prevent and/or contain a battery fire, and/or prevent damage to the battery when the housing is impacted, includes a ceramic base layer and fibrous ballistic layer bonded to the base layer.

### CROSS-REFERENCE TO RELATED APPLICATIONS

This application claims priority to provisional Application No. 62/580,469 filed on Nov. 2, 2017, which is incorporated herein by reference in its entirety.

### FIELD OF THE DISCLOSURE

This disclosure relates to enclosures for lithium ion batteries, and more particularly to such enclosures that effectively reduce the risk of spreading fire in the event of a catastrophic battery failure.

### BACKGROUND OF THE DISCLOSURE

Although catastrophic failures of lithium ion batteries are extremely rare, the consequences of such a failure can be devastating, particularly for batteries used to power systems in aircraft and other vehicles. Notable incidents have caused aircraft manufacturers to employ safeguards against the risk that a lithium ion battery failure would cause a fire to spread. These safeguards typically involve enclosing lithium ion batteries in stainless steel boxes having one-eighth thick walls, and providing the enclosures with a pressure relief system for venting gases away from the aircraft cabin and cockpit in the event of a catastrophic battery failure. However, the use of a stainless steel enclosure has added substantial weight, reducing or eliminating one of the primary benefits of using lithium ion batteries.

### SUMMARY OF THE DISCLOSURE

An enclosure for a battery is disclosed which is comprised of layers. A high temperature resistant ceramic is used as the base layer, and a fibrous ballistic layer comprised of high strength fibers, such as carbon fiber or a Kevlar/carbon fiber composite is affixed to the base layer using high temperature resins. An optional layer of graphene or hard setting polymer can be coated on the outside of the enclosure.

The fibrous ballistic layer or the combination of the fibrous ballistic layer and optional coating layer can absorb high impact, such as from a collision, explosion, shrapnel or ballistic rounds (up to 50 caliber armor piecing class). Shrapnel or ballistic rounds can then be caught by the underlying ceramic layer. The enclosure does not spall or produce internal damage upon attack via these means.

The enclosure is resistant to internal fire in the case of a battery malfunction, which can be caused by overcharging, undetected flaws in components such as in the separator material between electrodes, or by an unintended electrical event (e.g., lightning strike).

A lithium ion battery malfunction can cause a fire. In the event of fire, the internal enclosure construction material is resistant and non-reactive. Lithium cells or pouches typically vent at 500° F. and can reach temperatures as high as 1850° F., which is below the capability of the disclosed enclosure.

The disclosed enclosure can include a carbon-based filter system to capture toxins from vented gasses in the event of a fire. A pressure relief valve can be included to allow safe venting of the hot gasses from the vehicle, possibly using its normal exhaust venting system.

The proposed enclosure can include a battery management system within the box allowing active control and monitoring of the individual cell conditions. The battery management system can have a signal pass-through connection allowing communication with the vehicle over a CAN bus. If runaway conditions are detected by the battery management system, measures can be taken such as pumping Halon or other chemical agents into the box to either prevent or reduce the effects of fire.

The battery management system can be controlled over a CAN bus which requires multi-factor authentication for modification of system level controls and settings. The battery management system can rely on a physical key or token which can be physically inserted into a matching slot on the battery module. In addition to the physical token, commands can be provided over a vehicle/platform CAN bus either through operator input or via remote login over a wireless or wired access point. After the two forms of authentication are verified, system controls can be opened up and modifications can be made.

### BRIEF DESCRIPTION OF THE DRAWINGS

FIG. 1 is a schematic perspective of a battery housing.

FIG. 2 is a cross-sectional view of a battery housing containing lithium ion batteries.

FIG. 3 is a partial cross-sectional view of a wall of the battery housing of FIG. 2, showing details of a reinforced feed-through electrical connection.

FIG. 4 is a perspective view of a battery housing that is partially fabricated to illustrate the use of finger joints for connecting housing walls.

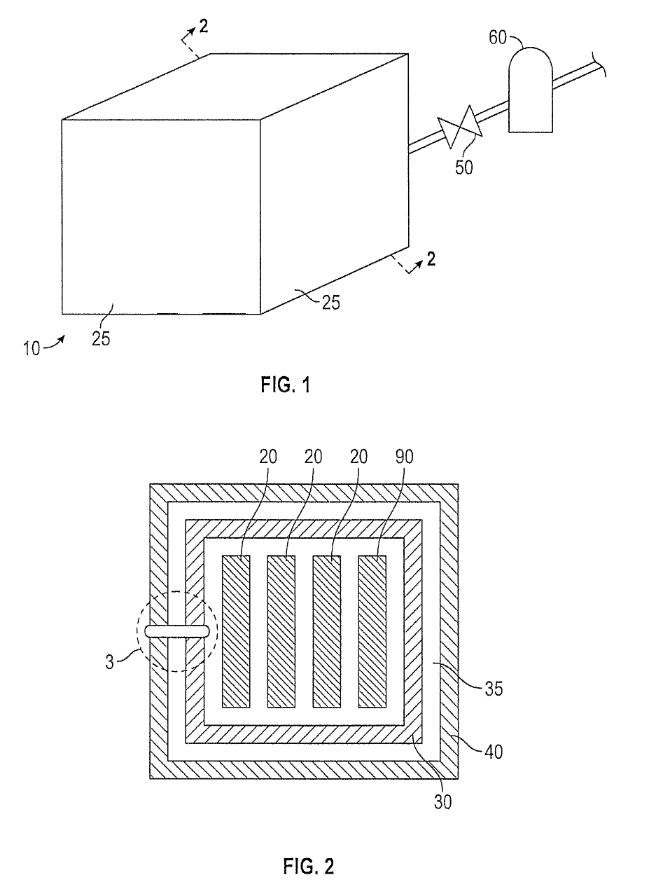

### DETAILED DESCRIPTION OF THE DISCLOSED EMBODIMENTS

Disclosed is a battery housing 10, especially useful for lithium ion batteries 20, comprising a plurality of walls 25 defining an enclosure, each wall including a high-temperature, resistant, ceramic base layer 30. The ceramic base layer 30 is relatively light in weight as compared to the stainless steel housings typically employed for lithium ion batteries used for emergency power and/or CPU starter power on commercial aircraft. Bonded to the ceramic base layer 30 on the outward or exterior side of the base layer is a fibrous ballistic layer 35 capable of absorbing high velocity impact and protecting the lithium ion cells from damage that could lead to a fire. Optionally, a coating layer 40 or multiple coating layers can be applied over the exterior side of the fibrous ballistic layers to provide enhanced aesthetics and/or functionality, including enhanced ballistic protection.

While the housings disclosed herein have exceptional utility in aviation applications, they can also be beneficially employed in other vehicles, including cars, trucks, buses and the like, and especially in military vehicles.

The term “high-temperature resistant” as used in reference to ceramic materials refers to a material having a flexural strength (also known as modulus of rupture or fracture strength) greater than 800 psi at all temperatures from 23° C. through 2000° C., greater than 1000 psi at all temperatures from 23° C. through 2000° C., or greater than 1200 psi at all temperatures from 23° C. through 2000° C.; and a thermal conductivity of about 10 BTU·in/hr.·°F·ft², less than 10 BTU·in/hr·°F·ft², about 6.5 BTU·in/hr·°F·ft² or less than 6.5 BTU·in/hr·°F·ft². Examples of ceramic materials that can be used include alumina-silica, silica, zirconia, silicon carbide, and alumina. Ultra-high-temperature ceramics, such as hafnium boride, hafnium carbide, hafnium nitride, zirconium boride, zirconium carbide, zirconium nitride, titanium boride, titanium carbide, titanium nitride, tantalum boride, tantalum carbide, tantalum nitride, niobium carbide, niobium nitride, vanadium carbide and vanadium nitride can also be used. These materials exhibit very good high temperature structural stability (e.g., maintain high flexural and composure strength at high temperatures, such as up to 2000° F. or 3000° F.), but tend to have somewhat higher thermal conductivity than silica, zirconia, and alumina. Higher material and fabrication costs are also associated with these ultra-high-temperature ceramics. Castable ceramics or machinable ceramics may be used in the fabrication of the battery housings of this disclosure. Such castable ceramics are commercially available from Cotronics Corp., Brooklyn, N.Y., and are sold under the names “Rescor Castable Ceramics” and “Rescor Machinable Ceramics.” Similar castable ceramic materials are available from the 3M Company, and are sold under the name “3M™ Castable Ceramics.”

A typical thickness for the base layer is from ¼ inch to ¾ inch, preferably from ⅜ inch to ⅝ inch. However, thicker and thinner base layers can be advantageously employed.

The term “fibrous ballistic layer” refers to a layer of material made of knitted, woven or randomly oriented high-strength fibers or yarns arranged in a single ply or multiple plies, that may be impregnated with, bonded together by, or distributed or disposed within a resin. Examples of high-strength fibers that can be used in fabricating the disclosed housing include polyaramid fibers, high strength extended chain polyethylene filament, extended chain propylene filament, polyvinyl alcohol filament, polyacrylonitrile filament, liquid-crystal polymer filament, glass filament, carbon fibers, and aramid copolymer fibers (e.g., those sold by DuPont under the name “Kevlar®.”). Combinations of these fibers may also be used. When multiple plies are used, the plies can be stitched or interwoven together. The fibrous bodies (e.g., knits, weaves, felts, or batts) can be impregnated with or contained in a resin such as polyurethane, polybutyral phenolic resin, polyolefin, polycarbonate, polyamide, polyimide, ionomer, polyvinyl chloride, and polyester. A commercially available fibrous ballistic layer that can be used for fabricating battery enclosure is sold by Fibre Glast Developments Corporation under the name “Nomex® Honeycomb.” This material is comprised of aramid fiber paper coated in a phenolic resin. The fibrous paper is arranged to form honeycomb-shaped cells.

The fibrous ballistic layer can be laminated to the ceramic layer, such as by thermal lamination, or the fibrous ballistic layer can be bonded to the ceramic layer with an adhesive. Examples of adhesives that can be used for fabricating the disclosed battery housing include inorganic (e.g., ceramic) adhesives such as colloidal silica (silica sol) or an alumina sol, and thermosetting adhesives such as epoxy adhesives.

The optional coating layer 40 or layers can be provided on a side of the fibrous ballistic layer opposite of the side of the ballistic layer 35 adhered to the ceramic layer 30. The coating layer 40 can comprise a thermoset resin coating or thermoset powder coating. Thermosettable resins that can be used include phenolic, amino, furan, silicone polyurethane, polyurea, epoxy, acrylic, polyester and vinyl ester resin systems. Such resin systems may contain functional and/or aesthetic fillers (pigments), as well as crosslinkers, initiators, stabilizers, etc. A preferred functional filler is graphene microparticle or nanoparticles, which impart enhanced ballistic resistance.

The battery housings described herein may be provided with a pressure relief valve 50, and an optional high pressure activated carbon filter 60 (such filters are commercially available to accommodate pressures up to at least 50 bar (725 psi)). The pressure relief valve can be either upstream or downstream of the high pressure activated carbon filter, and may either be external to, or contained within, the housing. The relief valve should be set to open at a predetermined pressure below the burst pressure of the enclosure. The high pressure activated carbon filter helps to prevent toxic gases generated during a battery fire from entering the environment. Regardless of whether a filter is used, it is desirable to vent any gases escaping from the battery enclosure away from the cabin or cockpit of an aircraft or other vehicle. Titanium tubing has proven suitable for venting such gases.

The enclosure can include internal mountings for receiving a plurality of modular lithium ion cells 20.

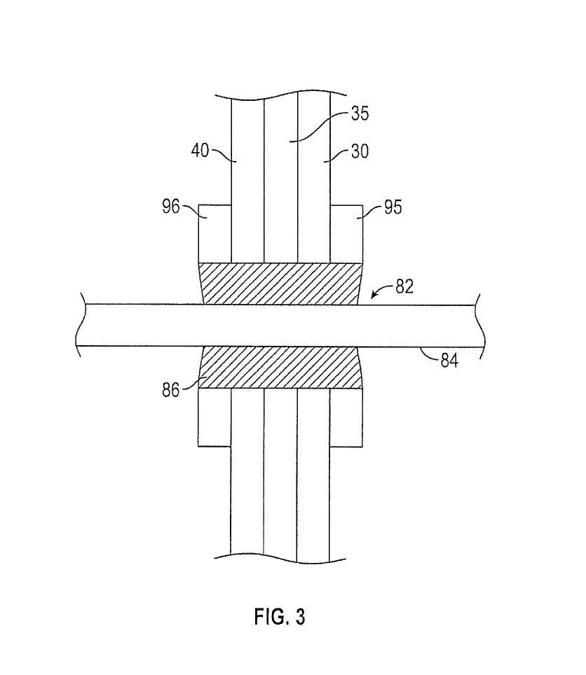

Power conduits and/or control signals to the battery management system can be facilitated with feed-through electrical connections (FIG. 3). These can be comprised of a reinforced opening 82 through which an electrical conductor 84 (e.g., a metal pin) passes. The conductor can be provided with an air-tight seal 86, such as a high temperature glass. The internal reinforcing ring 95 can, for example, be made of a ceramic material bonded to the base layer 35, and the external reinforcing ring can, for example, be made of a tough thermoplastic such as high density polyethylene bonded to the layer 40 such as with a thermoset adhesive (e.g., cyanoacrylate).

The battery housing may contain an internal charge management/status monitoring system 90 that prevents overcharging or inappropriate charge rates that could cause overheating and/or battery failure. The management system could monitor current, voltage and temperature. Such information could be used in an algorithm to control charging. Such information could also be transmitted (by wire or wirelessly) to a vehicle operation, flight recorder, or the like.

Electromagnetic impulse shielding and/or electrical shielding can be provided to the exterior or interior of the battery housing, if desired or necessary.

A controller area network (CAN) bus can be employed to allow electronic control units and other devices to communicate with the battery management/status monitoring system. Preferably, a multi-factor authentication is required for modification of system level controls and settings to prevent tampering. A physical key or token can be required in combination with commands provided over the CAN bus in order to access system level controls and settings.

The battery management/status monitoring system can be configured to detect dangerous, runaway conditions in the battery housing and take corrective actions, such as pumping Halon or other chemical agents into the housing to prevent or reduce the effects of fire.

The battery housings disclosed herein can be made in conformance with the specifications of MIL-PRF-32565, while also achieving reduced weight. Appropriate outside dimensions for battery enclosure used in military applications are 250 mm to 285 mm on each side of a cuboid box (e.g., 251±3 mm by 264±3 mm by 205±3 mm)

The enclosure can be provided with various communications interfaces, such as for any combination of USB, analog, discrete, Ethernet, wireless, etc. These connections can be provided for performing diagnostics on any internal electronics, either locally or remotely. A cybersecurity software protocol can be used to prevent unauthorized access to the internal electronics of the enclosure.

The housing structure disclosed herein can provide comparable or better protection than a conventional stainless steel housing, meeting the MIL-PRF-32565 standards, using a structure that is 20% lighter in weight and 33% lighter fully assembled (with batteries and electronics).

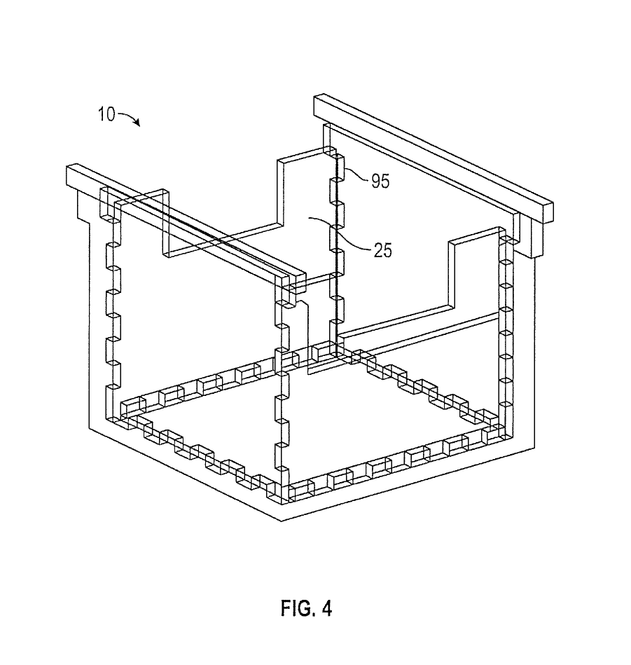

As illustrated in FIG. 4, the edges of walls 25 of housing 10 can be provided with fingers 95 or dovetails that can be used to mechanically join walls (sidewalls, bottom walls and/or top wall) together in an interlocking relationship (i.e., using finger joints and/or dovetail joints). This provides a strong connection between wall edges, which can be reinforced with additional fasteners, such as screws or adhesives. The joints can be sealed such as with glass or ceramic adhesives.

The described embodiments are preferred and/or illustrated, but are not limiting. Various modifications are considered within the purview and scope of the appended claims.

What is claimed is:

1. A battery housing, comprising;
an enclosure defined by walls, each wall including:
a ceramic base layer;
a fibrous ballistic layer; and
optionally, a thermoset coating layer.

2. The housing of claim 1, in which the base layer has a flexural strength greater than 800 psi at all temperatures from 23° C. through 2000° C.

3. The housing of claim 1, in which the base layer has a thermal conductivity of about 10 BTU·in/hr·°F.·ft² or less than 10 BTU·in/hr·°F.·ft².

4. The housing of claim 1, in which the base layer is made of an ultra-high-temperature ceramic.

5. The housing of claim 1, in which the base layer is made of a castable silica or alumina-silica material.

6. The housing of claim 1, wherein the fibrous ballistic layer is made of a fiber or yarn selected from polyaramid, polyethylene, polypropylene, polyvinyl alcohol, polyacrylonitrile, glass, carbon and aramid copolymer fibers.

7. The housing of claim 1, wherein the fibrous ballistic layer is comprised of woven fibers.

8. The housing of claim 1, wherein the fibrous ballistic layer is comprised of knitted fibers.

9. The housing of claim 1, wherein the fibrous ballistic layer is comprised of a fibrous batt.

10. The housing of claim 1, wherein the fibrous ballistic layer is comprised of aramid fiber paper arranged in the form of a honeycomb and coated with a resin.

11. The housing of claim 1, wherein the fibrous ballistic layer is adhered to the ceramic layer by a thermoset resin.

12. The housing of claim 1, including a thermoset coating layer containing graphene particles.

13. The housing of claim 1, further comprising a pressure relief valve.

14. The housing of claim 1, further comprising an actuated carbon filter configured to adsorb toxic materials outgassed from the housing in the event of a battery fire.

15. The housing of claim 1, further comprising a battery management system.
